(19) United States
(12) Patent Application Publication
(10) Pub. No.: US 2011/0088970 A1
(43) Pub. Date: Apr. 21, 2011

(54) ELEVATING PLATFORM AND A METHOD OF CONTROLLING SUCH A PLATFORM

(75) Inventor: Slaheddine BEJI, VIENNE (FR)

(73) Assignee: HAULOTTE GROUP, L'HORME (FR)

(21) Appl. No.: 12/890,945

(22) Filed: Sep. 27, 2010

(30) Foreign Application Priority Data
Sep. 28, 2009 (FR) 09 56679

(51) Int. Cl. B66F 11/04; G06F 19/00

(52) U.S. Cl. 182/18; 182/63.1; 701/49

(57) ABSTRACT

This elevating platform comprises a chassis equipped with a motor drive unit and with ground-engaging means, a platform, elevator means for elevating the platform relative to the chassis, sensors, each delivering a signal representative of the configuration of the elevating platform or of its environment, and a control unit for controlling the elevator means as a function of a plurality of parameters, including parameters corresponding to the signals delivered by the sensors. The elevating platform further comprises selector means for selecting at least one priority parameter and a threshold value for said parameter. The control unit is suitable for determining operating conditions for the elevating platform under which the threshold value for the priority parameter can be reached, and for controlling at least the elevator means within the limit of these operating conditions.

The invention relates to an elevating platform, and to a method of controlling such a platform.

It is known that the operation of an elevating platform can be made more reliable by determining limit values for certain operating parameters for such an elevating platform. It is known from FR-A-2 908 119 that it is possible to define a volume defined by a “safety nomogram” within which the top end of the boom of an elevating platform must be maintained, in order to prevent the elevating platform from tipping. As mentioned in EP-A-1 378 483, the stability envelope for an elevating platform is defined on the basis of the physical characteristics of said elevating platform, such as the length of the boom or the weight of certain portions of the machine. When the machine has an inclinable boom, the safety envelope relates mainly to the relationship between the maximum height that can be reached by the end of the boom and the offset of said end of the boom relative to a central axis of the chassis of the elevating platform. The operating conditions of an elevating platform also include limit values resulting from its environment, in particular from the speed of the wind to which it can be subjected, the slope or cant of the ground on which it is resting, or the weight of the load that it can bear.

The elevator means for elevating the platform are generally controlled by an electronic unit that takes account of those various parameters and limits the movements of the elevating platform when said elevating platform might operate outside its safety envelope or under conditions close to the limit values defined by the envelope. In this context, each of the parameters taken into account by a control unit can vary within a range defined by threshold values. Each of the threshold values is defined by taking account of the maximum threshold values for the other parameters. For example, the maximum allowable cant value for the ground on which the elevating platform stands is determined by taking account of the maximum height and of the maximum offset of the platform relative to the ground, and/or of the maximum weight of a load disposed on said platform and/or of the maximum speed of the wind to which the elevating platform can be subjected.

However, it is sometimes necessary for an elevating platform to operate under conditions that lie outside the normal operating range, which is not possible with current elevating platforms, without endangering the user and anyone in the vicinity of the elevating platform.

A particular object of the invention is to remedy those drawbacks by proposing a novel elevating platform that operates more reliably than prior art elevating platforms.

To this end, the invention provides an elevating platform comprising a chassis equipped with a motor drive unit and with ground-engaging means, a platform, elevator means for elevating the platform relative to the chassis, sensors, each delivering a signal representative of the configuration of the elevating platform or of its environment, and a control unit for controlling the elevator means as a function of a plurality of parameters, including parameters corresponding to the signals delivered by the sensors. Said elevating platform further comprises selector means for selecting at least one priority parameter and a threshold value for said parameter, and in that the control unit is suitable for determining operating conditions for the elevating platform under which the threshold value for the priority parameter can be reached, and for controlling at least the elevator means within the limit of these operating conditions.

By means of the invention, it is possible to identify one or more parameters as being priority parameters, it being possible for the priority parameter(s) to be taken into account in preferential manner for setting the operating conditions for the elevating platform. In particular, selecting a priority parameter makes it possible to use the elevating platform under conditions under which said parameter has a high value, even if, to do so, the limit values of one or more other parameters are reduced.

In advantageous but non-essential aspects of the invention, such an elevating platform may incorporate one or more of the following characteristics, taken in any technically feasible combination:
The selector means comprise a display suitable for showing various parameters that are suitable for being selected as priority parameter and at least one input member for inputting a command for selecting one of the displayed parameters as priority parameter, and for inputting a threshold value for said priority parameter.
A display device is provided for displaying, in graphical form and/or alphanumeric form, limit operating conditions for the elevating platform that are determined by the control unit.

The invention also provides a method of controlling an elevating work platform as mentioned above, which method makes it possible to adapt operation of the elevating platform to suit its planned operating conditions. This method comprises steps consisting in:

a) determining at least one priority parameter from among the parameters used by the control unit;

b) choosing a threshold value for said priority parameter;

c) determining, as a function of the threshold value chosen in step b), operating conditions for the elevating platform, under which conditions the threshold value for the priority parameter can be reached; and

d) controlling at least the elevator means within the limit of these operating conditions determined in step c).

In advantageous but non-essential aspects of the invention, such a method may incorporate one or more of the following characteristics, taken in any technically feasible combination:
During step c), at least one limit value is determined for at least one other parameter used by the control unit, as a function of the threshold value chosen for the priority parameter. In which case, step c) is performed at least in part by calculating the limit value of the other parameter. Alternatively or in addition, step c) may be performed at least in part by accessing a memory containing data relating to a plurality of predetermined operating configurations for the elevating platform.
An additional step d) is provided in which the operating conditions determined during step c) are displayed.
Another step e) is provided subsequent to step b) and prior to step c) and in which it is checked that the value determined in step b) is consistent with the configuration of the machine that is determined by the sensors, while step c) is implemented as a function of the result of the consistency check of this other step.
The priority parameter is representative of the choice made by a user as to whether or not to govern operation of the elevating platform.

The invention can be better understood and other advantages of the invention appear more clearly from the following description of an embodiment of an elevating platform of the invention and of a method of controlling said elevating platform, the description being given by way of example and with reference to the accompanying drawings, in which:

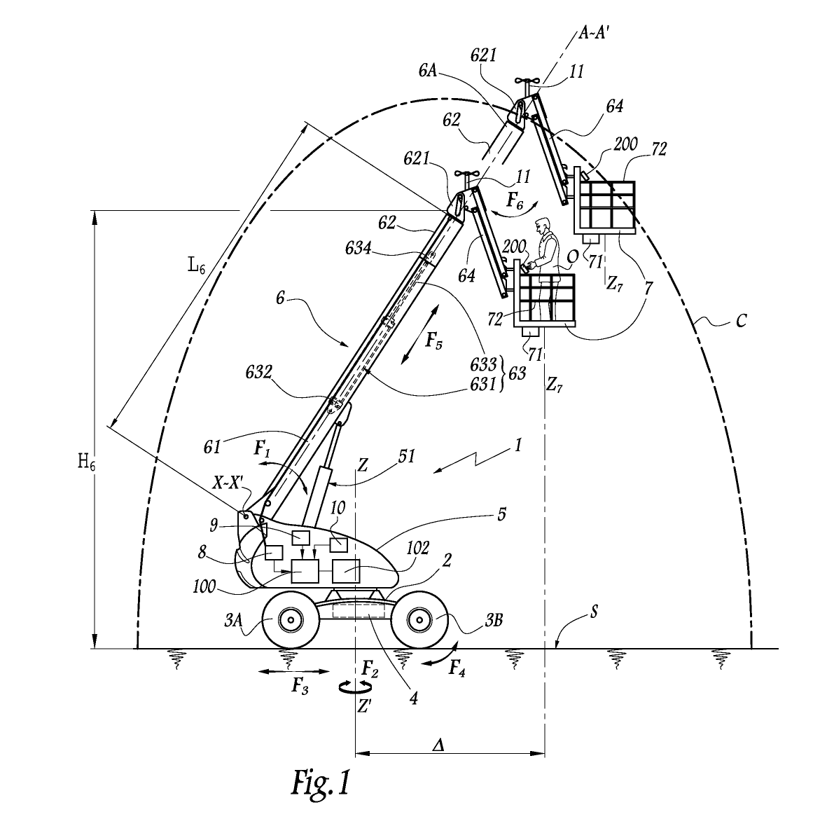

FIG. 1 is a diagrammatic side view of a boom lit of the invention;

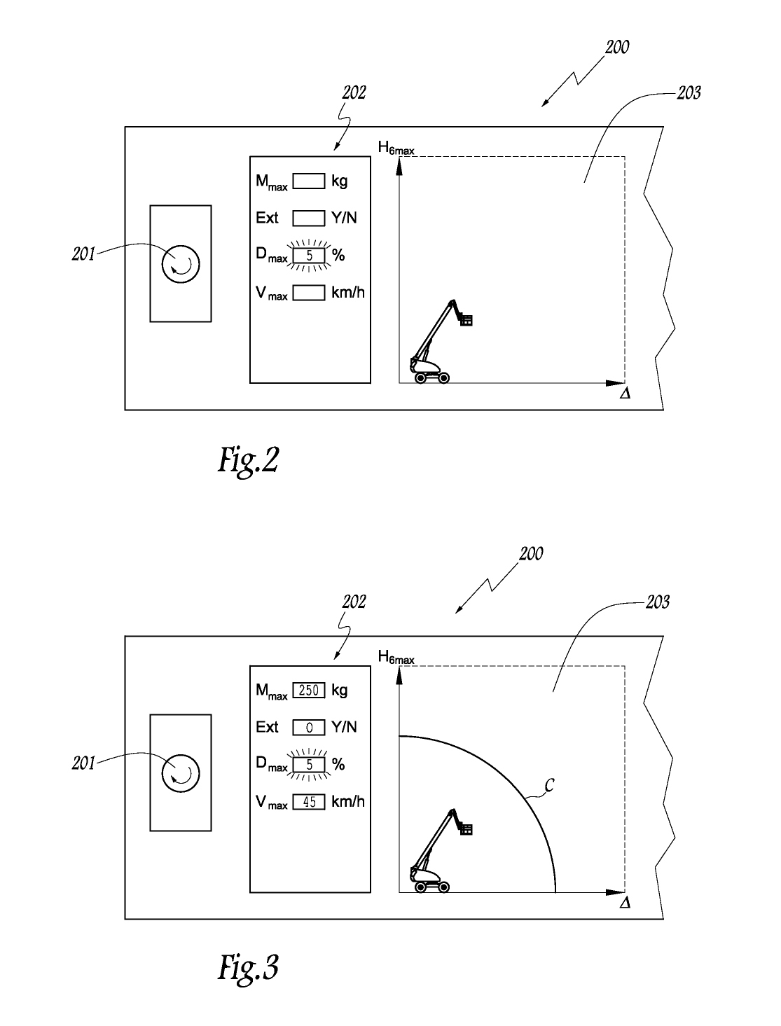

FIG. 2 is a fragmentary front view of a control console that belongs to the elevating platform of FIG. 1, when the control means for controlling the elevating platform are in a first configuration;

FIG. 3 is a view analogous to FIG. 2 when the control means are in a second configuration; and

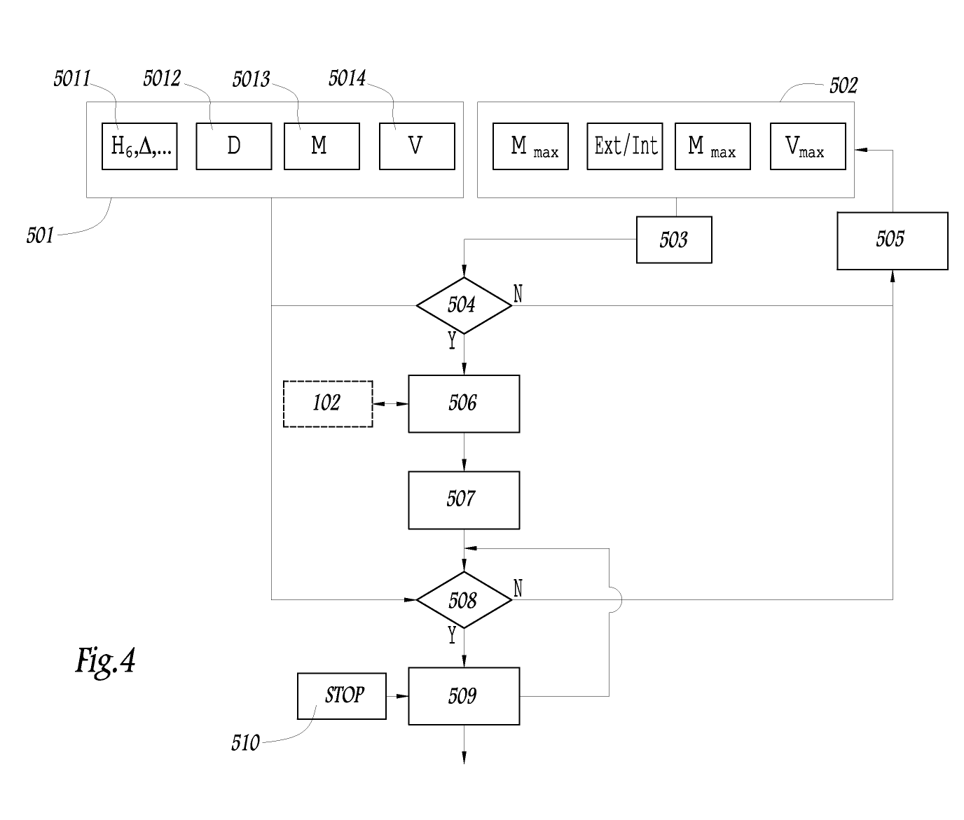

FIG. 4 is a flow chart of a method of controlling the elevating platform of FIG. 1 by means of the console of FIGS. 2 and 3.

The elevating platform 1 shown in FIG. 1 includes a chassis 2 that stands on the surface S of the ground via four wheels, two of which are visible, referenced 3A and 3B, the four wheels forming means for engaging the ground. In place of the wheels, the chassis 2 could be equipped with crawler tracks or with other members for engaging the ground. The wheel 3A is a driven wheel, i.e. it is a wheel connected to an electric motor 4 incorporated into the chassis 2. The wheel 3B is steerable, i.e. its angular position relative to the chassis 2 can be varied, thereby making it possible to steer the elevating platform 1.

A base 5 is pivotally mounted on the chassis 2 to pivot about an axis Z-Z′ that is perpendicular to the surface S of the ground. A telescopic boom 6 is hinged to the base 5 about an axis X-X′ that is perpendicular to the axis Z-Z′. Double-headed arrow F₁ in FIG. 1 represents the pivoting movement of the boom 6 about the axis X-X′, this movement being controlled by means of an actuator 51 disposed between the components 5 and 6.

Double-headed arrow F₂ shows the pivoting movement of the base 5 relative to the chassis 2, about the axis Z-Z′. Double-headed arrow F₃ represents the forward and reverse movement of the elevating platform relative to the surface S, whereas double-headed arrow F₄ represents the possible changes in direction of the elevating platform 1.

The boom 6 is telescopic in that it comprises a tube 61 that is hinged to the base 5 and a portion 62 that is adapted to slide inside the tube 61, while being controlled by a hydraulic actuator 63 having a body 631 secured to the tube 61 by means of a fastening lug 632. The rod 633 of the actuator 63 is equipped with a fastening lug 634 for fastening to the portion 62.

As a function of the activation of the actuator 63, the portion 62 moves parallel to a longitudinal axis A-A′ of the boom 6, relative to the tube 61, as represented by doubled-headed arrow F₅. Two positions of the portion 62 relative to the tube 61 are shown in FIG. 1, and they illustrate this possibility of extension of the boom 6.

The top end 6A of the boom, i.e. the portion 62 that is furthest away from the tube 61 is provided with a yoke joint 621 for fastening to a parallelogram structure 64 from which a platform 7 is suspended, on which platform an operator O can stand, or on which platform loads to be elevated can be placed.

The structure 64 is equipped with an actuator (not shown) such as a jack, making it possible to move the platform 7 while keeping it parallel to itself, as represented by double-headed arrow F₆.

In order to avoid the risks of the elevating platform 1 tipping over, it is known that the top end 6A of the boom 6 must remain inside a volume having a limit represented by the curve C in FIG. 1, said curve sometimes being referred to as a “safety nomogram” or as a “work nomogram” for the elevating platform.

Reference L₆ designates the length of the boom 6 measured from the axis X-X′ to the junction zone where the portion 62 meets the yoke joint 621. This length L₆ is variable as a function of the action of the actuator 63. Reference Z₇ designates an axis parallel to the axis Z-Z′ and passing through the center of the platform 7. Reference Δ designates the lateral offset of the platform 7 relative to the chassis 2, this offset being defined as being the radial distance between the axes Z-Z′ and Z₇. This lateral offset is variable as a function of the three-dimensional position of the platform 7.

Reference H₆ is the height of the top end 6A of the boom 6 relative to the ground. The height H₆ varies as a function of the length L₆ of the angle of inclination of the boom relative to the axis Z-Z′.

A sensor 8 makes it possible to determine the length L₆ by direct measurement, whereas a second sensor 9 makes it possible to measure the angle of inclination of the boom 6.

Other sensors (not shown) make it possible to determine the position of the parallelogram structure 64 relative to the boom 6.

Another sensor 10 incorporated in the base 5 makes it possible to determine the angle of any cant of the surface S on which the elevating platform 1 is situated. An anemometer 11 is mounted in the vicinity of the yoke joint 621 and makes it possible to determine the speed of the wind in the vicinity of the top portion of the boom 6 and of the platform 7.

A weight measurement device 71 fastened to the platform 7 makes it possible to determine the weight of the load carried on the platform 7, whether it be the weight of the operator O and/or the weight of the objects that the operator wishes to elevate relative to the surface of the ground S. The device 71 is part of a system for monitoring the carried load, the other components of the system not being shown so as to make the drawing clearer.

The output signals from the various sensors and from the device are delivered to an electronic control unit 100 that, in particular, controls the motor 4, the actuators 51 and 63, and the actuator (not shown) for actuating the parallelogram structure 64.

A control console 200 is mounted on a guardrail 72 of the platform 7.

This console enables the operator O to control the wheels 3B, the motor 4, the actuators 51 and 63, and the means for moving the structure 64. For this purpose, the console is equipped with one or more control members, e.g. of the joystick type, and with a display that are incorporated into the portion of the console 20 that is not visible in FIGS. 2 and 3.

The console 200 also enables the operator O to give preference to a parameter relating to the elevating platform 1 for the purpose of determining the safe operating conditions therefor.

The portion of the console 200 that is shown in FIG. 2 includes a rotary knob 201 that can be pushed in to select a value. This console portion 200 also includes a primary display 202 designed to display the maximum weight Mₘₐₓ that can be supported by the platform 7 when the elevating platform 1 is operating normally. The display 202 displays a value “yes” (Y) or a value “no” (N) corresponding to whether the elevating platform can be used in an exterior environment, i.e. outdoors, in particular an environment subjected to wind speed. The display 202 also makes it possible to display the maximum can value Dₘₐₓ, expressed in percents and concerning the surface S of the ground on which stands the elevating platform 1. Finally, the display 202 may display the maximum wind speed Vₘₐₓ, expressed in kilometers per hour (km/h), to which the elevating platform 1 can be subjected under normal outdoor operating conditions.

The console 200 also includes a graphical display 203 showing a graphical representation of the elevating platform 1 and, along the x-axis, the offset Δ of the platform 2 relative to the base 5, and, up the y-axis, the height H₆ of the boom 6.

When it is desired to use the elevating platform 1, a first step 501 of a method of controlling the elevating platform is implemented. In this first step, the current configuration of the machine and of its environment is determined. This step 501 breaks down into an elementary step 5011 for determining the position of the articulated structure made up of the boom 6 and of the parallelogram structure. This determination takes place by means of the sensors 8 and 9, and by means of the sensor associated with the structure 64. It makes it possible, in particular, to determine the height H₆ and the offset Δ. The step 501 also includes an elementary step 5012 in which the cant D of the surface S, i.e. its inclination relative to the horizontal is determined. This determination takes place by means of the sensor 10. During an elementary step 5013 of the step 501, the value of the weight M carried by the platform is determined, by means of the cell 71. During another elementary step 5014 of the step 501, the speed of the wind to which the articulated structure of the elevating platform 1 is subjected is determined, by means of the anemometer 11.

The method of the invention also includes a step 502 during which the operator O selects, from among the parameters displayable on the display 202, that parameter that the operator considers as being a priority for operation of the elevating platform. Said parameter may be the maximum weight that can be carried on the platform 7, i.e. Mₘₐₓ. Said parameter may be whether the elevating platform 1 can work indoors or outdoors, i.e. Ext/Int. Said parameter may be the maximum value Dₘₐₓ of the cant of a surface on which the elevating platform 1 can operate. Said parameter may also be the maximum speed Vₘₐₓ of the wind to which the elevating platform 1 can be subjected.

The parameter considered by the user as being a priority or as to be given preference is selected by turning the knob 201 until a window disposed facing the name of the parameter is highlighted by brightening. In the example shown in FIG. 2, the user has highlighted the window corresponding to maximum allowable cant.

After highlighting the window corresponding to the parameter to be given preference, Dₘₐₓ in the example, the user actually selects the parameter by pressing on the knob 201 while the corresponding window is highlighted. This corresponds to the step 502 of selecting the preferred parameter.

During a step 503 following step 502, the user chooses a threshold value for the parameter that said user has identified as to be given preference. This threshold valve can be an upper or a lower limit value. In practice, the threshold value of the preferred parameter is selected by turning the knob 1 until the desired value is displayed in the highlighted window.

In the example shown in FIG. 2, the user has selected a value of 5% as being the upper value for the cant D of the surface of the ground S on which the elevating platform can operate.

During a subsequent step 504, the unit 100 checks that the selected threshold value for the preferred parameter, in the example the value of 5% for the maximum allowable cant Dₘₐₓ, is consistent with the configuration of the machine and of its environment as determined in step 501. If this consistency check is negative, the unit 100 goes to a step 505 for making the machine safe, and the user is invited to implement steps 502 and 503 again, by selecting either another parameter as the parameter to be given preference, or another threshold value for the previously selected parameter.

If step 504 determines that the threshold value selected for the preferred parameter is consistent with the configuration of the machine that is determined in step 501, the unit 100 goes to a step 506 during which it determines the allowable threshold values for the other operating parameters of the machine. This step 506 may be performed by means of calculations performed by the unit 100. It may also be performed by accessing a memory 102 containing data relating to various possible configurations for the elevating platform 1, the unit 100 then selecting from among this data a set of data corresponding to a configuration in which the selected value for the preferred parameter, in the example 5% for the maximum cant Dₘₐₓ, can be reached.

In a variant, the step 506 may be performed both by accessing the memory 102 and by performing calculations.

At the end of step 506, the limit configuration determined by the unit 100 is displayed on the console 200, as shown in FIG. 3. More precisely, threshold values determined for the parameters other than the parameter that is given preference are displayed firstly on the primary display 202, and secondly in graphical form on the display 203. The threshold values displayed on the primary display 202 concern the maximum weight that can be disposed on the platform 7, i.e. Mₘₐₓ, whether or not the elevating platform can be used outdoors (“Ext” value “Y” or “N”), and maximum allowable speed for the wind to which the elevating platform is subjected, i.e. Vₘₐₓ.

In addition, the step 506 also makes it possible to determine the safety nomogram or the work nomogram C to be used, which nomogram is represented in graphical form on the display 203, with a maximum height for the boom 6 H₆ₘₐₓ represented as a function of the offset Δ of the platform 7.

The operator O situated on the platform 7 can thus be informed of the influence that the choice made by the operator for the maximum value Dₘₐₓ of the cant has on the other operating parameters of the elevating platform 1, in terms of maximum carried weight, in terms of operating outdoors, in terms of maximum allowable wind speed, and in terms of maximum allowable height as a function of the offset.

Then, in a subsequent step 508, the limit values determined in step 506 are compared with the values determined during the step 501 that is repeated at regular intervals during use of the elevating platform 1, e.g. every 40 milliseconds (ms). If the result of this consistency check is positive, i.e. if the values determined in step 501 do not exceed the values determined in step 506, then the operating conditions determined by the unit 100 are used by said unit in step 509 to control the actuators 51 and 63, and the means for actuating the parallelogram structure 64 as a function of the movement instructions input by the operator O. These operating conditions may also be used to control the motor 4 and the steerable wheels 3B.

If the consistency check in step 508 shows that the values determined in step 501 might exceed one or more of the threshold values determined in step 506, the unit goes to step 505 for making the elevating platform 1 safe.

Thus, by means of the invention, the user can choose a parameter, such as maximum allowable cant Dₘₐₓ in the example mentioned above, as being a priority parameter for determining the operating conditions of the elevating platform 1, i.e., in practice, the limit or threshold values of the other parameters that are determined as a function of a threshold value set for this priority parameter. The invention thus makes it possible to cause the elevating platform to operate under conditions that are not necessarily accessible for a conventional elevating platform, insofar as the value selected for the priority parameter can lie outside the conventional operating ranges for known elevating platforms.

Once the value of the preferred parameter has been chosen, that value can be used to limit the threshold values of the other parameters, relative to a conventional configuration.

For example, the value of 5% chosen for the maximum allowable cant can result in the maximum carried load being reduced to 250 kilograms (kg) whereas the elevating platform can normally carry a load of 400 kg under normal operating conditions, under which the possible cant is less than 3%.

In a variant, at this stage, a choice may be left up to the operator for indicating which parameter, other than the preferred parameter, can have its value reduced or modified preferably so that the selected value for the preferred parameter can be reached. In the above example, the operator can choose that, during the step 506, the value for the maximum carried load Mₘₐₓ be reduced preferably to the value for maximum offset Δ. In another approach, the operator may prefer the maximum height H₆ₘₐₓ to be reduced rather than modifying the other parameters. In another variant, the operator may choose a plurality of parameters, e.g. Mₘₐₓ and H₆ₘₐₓ, the values of which are adjusted preferably as a function of the selected value for the preferred parameter.

The invention is described above in the situation in which the operator has the choice between four parameters as potential priority parameters. Naturally, the number of these potential priority parameters and their types can be adapted as a function of the choices of the designer of the elevating platform. Other parameters that can be used as priority parameter are the number of persons that can be on the platform 7, the maximum offset Δ, or the height H₆.

Another potential priority parameter concerns whether a referenced user, who can be termed an “administrator”, might wish to govern the performance of an elevating platform in order to broaden its range. In other words, a priority parameter can concern whether or not an administrator gives access to all of the operating ranges of an elevating platform. The use of such a parameter as the priority parameter enables the administrator, who may be the representative of an elevating platform rental business, to limit the performance of an elevating platform when it is hired out for a precise purpose, in place of an elevating platform having lower theoretical performance. This enables a rental business to broaden its range using the same elevating platform.

The invention is described above in the situation when the elevating platform 1 is equipped with an anemometer 11. By way of a variant, said anemometer can be replaced with a portion of the console 200 in which the operator O directly indicates the maximum value of the speed of the wind to which the elevating platform 1 can be subjected, within the normative limits. In this case, during the step 5014, the maximum value indicated by the operator is taken into account. For normative reasons, in Europe, the value indicated by the operator cannot be less than 45 km/h, if the elevating platform is designed to be used outdoors.

The means for selecting the preferred parameter(s) may be different from the console 200 shown in the figures. For example, they may comprise cursors that are mounted to move in translation, “+” and “−” keys making it possible to increase or to decrease a value etc.

The invention is described above in the situation in which a single priority parameter is to be given preference. However, in a variant, it is possible to give preference to more than one priority parameter, the allowable values of the other parameters being determined as a function of the values of these priority parameters.

The invention has been shown in the situation in which the elevating platform is an elevating platform having an inclinable telescopic boom. It is applicable to any type of elevating platform, in particular scissor lifts and elevating platforms having vertical booms or masts, regardless of whether such elevating platforms are self-propelled or towed.

The invention is described above in the situation in which the selected threshold value is a maximum value, in particular when it is maximum allowable cant. It may also be a minimum value, e.g. for weight Mₘₐₓ, or a binary value for whether or not the elevating platform can be used outdoors.

The invention can be implemented with any unit system to measure the parameter, e.g. pounds instead of kilograms as MPH instead of Km/h.

1. An elevating platform comprising a chassis equipped with a motor drive unit and with ground-engaging means, a platform, elevator means for elevating the platform relative to the chassis, sensors, each delivering a signal representative of the configuration of the elevating platform or of its environment, and a control unit for controlling the elevator means as a function of a plurality of parameters, including parameters corresponding to the signals delivered by the sensors, whereas said elevating platform further comprises selector means for selecting at least one priority parameter and a threshold value for said parameter, and wherein the control unit is suitable for determining operating conditions for the elevating platform under which the threshold value for the priority parameter can be reached, and for controlling at least the elevator means within the limit of these operating conditions.

2. An elevating platform according to claim 1, wherein the selector means comprise a display suitable for showing various parameters that are suitable for being selected as priority parameter and at least one input member for inputting a command for selecting one of the displayed parameters as priority parameter, and for inputting a threshold value for said priority parameter.

3. An elevating platform according to claim 1, wherein it further comprises at least one display device for displaying, in graphical form and/or alphanumeric form, limit operating conditions for the elevating platform that are determined by the control unit.

4. A method of controlling an elevating work platform comprising a chassis equipped with a motor drive unit and with ground-engaging means, a platform, elevator means for elevating the platform relative to the chassis, sensors, each delivering a signal representative of the configuration of the elevating platform or of its environment, and a control unit for controlling the elevator means as a function of a plurality of parameters, including parameters corresponding to the signals delivered by the sensors, wherein said method comprises steps consisting in:
a) determining at least one priority parameter from among the parameters used by the control unit;
b) choosing a threshold value for said priority parameter;
c) determining, as a function of the threshold value chosen in step b), operating conditions for the elevating platform, under which conditions the threshold value for the priority parameter can be reached; and
d) controlling at least the elevator means within the limit of these operating conditions determined in step c).

5. A method according to claim 4, wherein, during step c), at least one limit value is determined for at least one other parameter used by the control unit, as a function of the threshold value chosen for the priority parameter.

6. A method according to claim 5, wherein step c) is performed at least in part by calculating the limit value of the other parameter.

7. A method according to claims 4, wherein step c) is performed at least in part by accessing a memory containing data relating to a plurality of predetermined operating configurations for the elevating platform.

8. A method according to claim 4, wherein it further comprises an additional step d) in which the operating conditions determined during step c) are displayed.

9. A method according to claim 4, wherein it further comprises a step e) subsequent to step b) and prior to step c) and in which it is checked that the value determined in step b) is consistent with the configuration of the machine that is determined by the sensors, and in that step c) is implemented as a function of the result of the consistency check of step e).

10. A method according to claim 4, wherein the priority parameter is representative of the choice made by a user as to whether or not to govern operation of the elevating platform.
